(19) United States
(12) Patent Application Publication
(10) Pub. No.: US 2016/0259367 A1
(43) Pub. Date: Sep. 8, 2016

(54) TOUCH MODULE, FABRICATING METHOD THEREOF, AND SMART WATCH

(71) Applicant: Acer Incorporated, New Taipei City (TW)

(72) Inventors: Yu-Cheng Huang, New Taipei City (TW); Chun-Hsien Chen, New Taipei City (TW); Hui-Ping Sun, New Taipei City (TW); Yen-Chou Chueh, New Taipei City (TW); Chun-Hung Wen, New Taipei City (TW)

(21) Appl. No.: 14/684,417

(22) Filed: Apr. 12, 2015

(30) Foreign Application Priority Data
Mar. 4, 2015 (TW) 104106835

(51) Int. Cl. G06F 1/16; G06F 3/041

(52) U.S. Cl. CPC G06F 1/163; G06F 1/1637; G06F 3/041

(57) ABSTRACT

A touch module includes a housing, a cover, a connecting element, and a touch element. The cover includes a main body portion and a step portion located at a periphery of the main body portion, and a thickness of the main body portion is greater than a thickness of the step portion. The connecting element is located between the step portion and the housing. The touch element is located at a side of the cover and at the inside of the housing. A fabricating method of the touch module and a smart watch having the touch module are also provided.

### CROSS-REFERENCE TO RELATED APPLICATION

This application claims the priority benefit of Taiwan application serial no. 104106835, filed on Mar. 4, 2015. The entirety of the above-mentioned patent application is hereby incorporated by reference herein and made a part of this specification.

### BACKGROUND

1. Field of the Invention

The disclosure relates to a touch module and a fabricating method thereof; particularly, the disclosure relates to a touch module of a smart watch and a fabricating method thereof.

2. Description of Related Art

Touch modules of existing electronic products (e.g., smart watches) may be adhered to the electronic products, and the most common way to adhere the touch modules to the electronic products lies in adhering the touch modules to front frame planes of the electronic products via adhesives.

FIG. 1 is a schematic cross-sectional diagram illustrating a conventional touch module. With reference to FIG. 1, the conventional touch module 100 has a housing 110, a touch element 120, and an adhesive 130. The housing 110 has a front frame plane 110a. The touch element 120 is adhered to the front frame plane 110a via the adhesive 130. Said method of assembling the housing and the touch element is the most popular method because the assembly is convenient and maintenance and repair can be easily done. As long as the front frame plane 110a is foil ied on the entire inner circumferential wall of the housing 110, the touch element 120 can be adhered to the housing 110 via the adhesive 130.

Nevertheless, dummy areas may be formed at peripheries of the electronic products if said assembling method is applied. FIG. 2 is a schematic diagram illustrating an appearance of a smart watch having the touch module depicted in FIG. 1. With reference to FIG. 1 and FIG. 2, a dummy area 140 is located at a periphery of a smart watch 102, and the dummy area 140 cannot function in the same manner as a display screen does. As to the look of the smart watch 102, the dummy area 140 may leave an impression that a display area 102a of the smart watch 102 seems to be small, which poses a negative impact on the perception of users about the exterior design of the smart watch 102.

Solutions to said issue have been developed for some of the electronic products. FIG. 3 is a schematic cross-sectional diagram illustrating another conventional touch module. With reference to FIG. 3, the touch module 200 has a housing 210, a cover 220, an adhesive 230, a decorative sheet 240, optical films 250, 252, 254, and 256, and sensor films 260 and 262.

In the touch module 200, it can be observed that the size of the touch element (i.e., the stacked structure constituted by the optical films 250, 252, 254, and 256 and the sensor films 260 and 262) is greater than the size of the cover 220; thereby, the touch element is able to be connected to the housing 210 via the adhesive 230 and can be fixed from the inside of the housing 210.

The touch module 200 shown in FIG. 3 does not encounter the issue of the dummy area as depicted in FIG. 1 and FIG. 2, and the resultant smart watch can have a plain and pared-down design. Said assembling method, however, complicates the fabrication of the touch module 200.

In particular, the user may observe the electrical circuits inside the touch module 200 through gaps 270. In consideration of the overall look, the decorative sheet 240 is required for shielding the internal electrical circuits. The adhesive 230 is arranged between the housing 210 and a protruding upper surface 242 of the decorative sheet 240.

Hence, plural films are required to be adhered to the cover 220 of the touch module 200 shown in FIG. 3; namely, the optical film 250, the decorative sheet 240, the optical films 252, 254, and 256, and the sensor films 260 and 262 need be adhered to the cover 220. During the adhesion process, the yield of adhering individual films is fixed (e.g., the rate of successful adhesion is 80%), and a resultant first pass yield (i.e., the manufacturing yield of the final product) can be obtained by multiplying the yield of adhering the individual films. Apparently, the more the films which are required to be adhered, the lower the first pass yield.

Besides, the adhesive 230 is arranged on the protruding film (i.e., on the protruding upper surface 242 of the decorative sheet 240 shown in FIG. 3), so as to connect the touch element to the housing 210. Since said films yield low strength and has poor durability, the resultant manufacturing reliability is rather unsatisfactory.

### SUMMARY

The disclosure is directed to a touch module, a fabricating method thereof, and a smart watch having the touch module. Since the smart watch having the touch module is not equipped with the dummy area described above, the smart watch can have a plain and pared-down design; in addition, the fabricating method of the touch module can be characterized by low manufacturing costs, high manufacturing yield, and high manufacturing reliability.

In an embodiment of the disclosure, a touch module that includes a housing, a cover, a connecting element, and a touch element is provided. The cover includes a main body portion and a step portion located at a periphery of the main body portion, and a thickness of the main body portion is greater than a thickness of the step portion. The connecting element is located between the step portion and the housing. The touch element is located at a side of the cover and at an inside of the housing.

In an embodiment of the disclosure, a fabricating method of a touch module is provided, and the fabricating method includes: providing a housing; providing a cover including a main body portion and a step portion located at a periphery of the main body portion; providing a connecting element between the step portion and the housing; providing a touch element at a side of the cover and at an inside of the housing; and assembling the housing, the cover, the connecting element, and the touch element. Here, a thickness of the main body portion is greater than a thickness of the step portion.

In an embodiment of the disclosure, a smart watch that includes said touch module and a display element is provided. The display element is located at a side of the touch element.

In view of the above, the cover of the touch module provided in an embodiment of the disclosure has the step portion where the connecting element can be arranged to connect the touch element and the housing. Thereby, compared to the conventional touch module, the touch module described herein does not require the decorative sheet, and thus the number of the stacked films can be reduced.

Additionally, the electronic product having the touch module provided herein is not equipped with the dummy area and is thus characterized by the plain and pared-down design. Moreover, the step portion of the cover allows the process of stacking the films to be simplified, thus lowering down the manufacturing costs, improving the manufacturing yield (the first pass yield), simplifying the manufacturing steps, enhancing the manufacturing reliability, and so on.

In order to make the aforementioned and other features and advantages of the disclosure more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional diagram illustrating a conventional touch module.

FIG. 2 is a schematic diagram illustrating an appearance of a smart watch having the touch module depicted in FIG. 1.

FIG. 3 is a schematic cross-sectional diagram illustrating another conventional touch module.

FIG. 4 is a schematic cross-sectional diagram illustrating a touch module according to an embodiment of the disclosure.

FIG. 5 is a photograph of a cover according to an embodiment of the disclosure.

FIG. 6A is a flowchart illustrating a fabricating method of a touch module according to an embodiment of the disclosure.

FIG. 6B is a schematic diagram illustrating a process of assembling a touch module according to an embodiment of the disclosure.

FIG. 7 is a schematic cross-sectional diagram illustrating a smart watch having the touch module depicted in FIG. 4.

### DETAILED DESCRIPTION OF DISCLOSED EMBODIMENTS

FIG. 4 is a schematic cross-sectional diagram illustrating a touch module according to an embodiment of the disclosure. With reference to FIG. 4, the touch module 300 includes a housing 310, a cover 320, a connecting element 330, and a touch element 340. The cover 320 includes a main body portion 322 and a step portion 324 located at a periphery of the main body portion 322, and a thickness d1 of the main body portion 322 is greater than a thickness d2 of the step portion 324. The connecting element 330 is located between the step portion 324 and the housing 310. The touch element 340 is located at a side of the cover 320 and at an inside of the housing 310.

Several embodiments of each element are provided hereinafter. As shown in FIG. 4, the housing 310 may have a horizontal extension portion 312 and a vertical extension portion 314, and the connecting element 330 is located between the step portion 324 and the horizontal extension portion 312.

The housing 310 depicted in FIG. 4 may also include an opening 310a, and the main body portion 322 is lodged in the opening 310a in an inside-out manner from the inside of the housing 310. As shown in FIG. 4, the size of the opening 310a may be changed by adjusting the length of the horizontal extension portion 312; furthermore, the size of the touch area of the touch module 300 can be changed by properly adjusting the main body portion 322 of the cover 320.

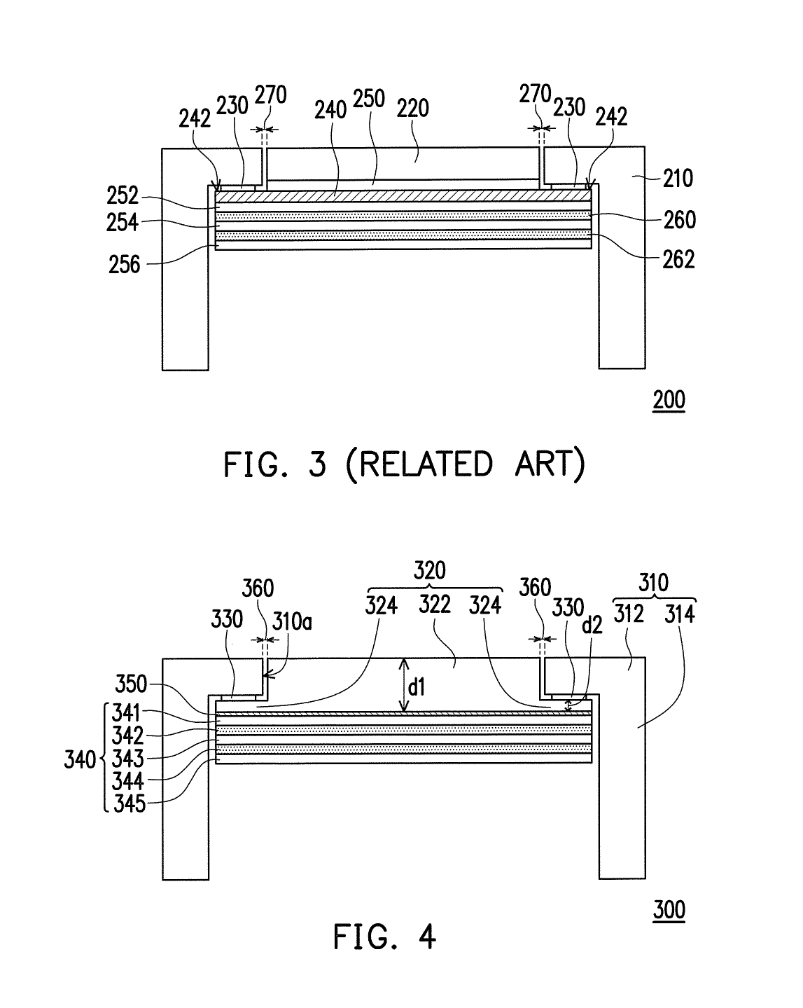

Besides, the main body portion 322 and the step portion 324 of the cover 320 are integrally formed, and thus the connecting element 330 can be arranged on the step portion 324 characterized by favorable manufacturing reliability, so as to connect the cover 320 and the housing 310. Compared to the conventional touch module having the decorative sheet 240 as shown in FIG. 3, the touch module depicted in FIG. 4 has the reduced number of stacked films.

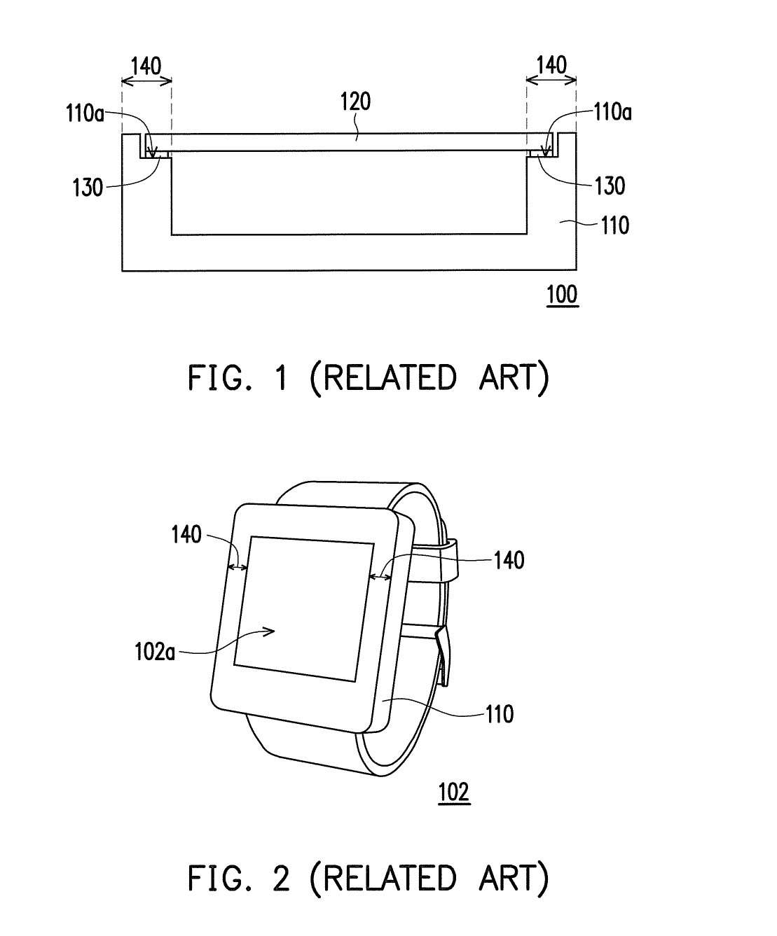

That is, since the cover 320 is equipped with the step portion 324, and the step portion 324 and the horizontal extension portion 312 are arranged opposite to each other, the step portion 324 can serve to be adhered to an adhesive and can further be adhered to the horizontal extension portion 312 via the adhesive. As a result, the cover 320 can be assembled to the housing 310 from the inside of the housing 310, so as not to form the dummy area 140 shown in FIG. 1 and FIG. 2 and so as to render the resultant product border-free.

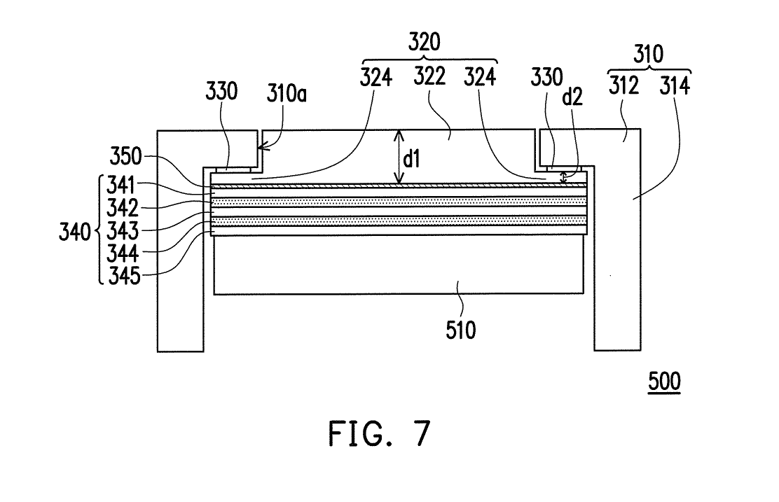

The cover 320 can be made of transparent glass, sapphire, or similar materials, for instance. Users are able to use the touch element 340 through the cover 320 and observe the information displayed on a display element 510 (shown in FIG. 7).

Besides, the connecting element 330 may be made of adhesive resin or adhesives. For instance, ultraviolet curable resin characterized by ultraviolet curability or any other appropriate material can be used to make the connecting element 330.

The touch element 340 shown in FIG. 4 may include a first optical film 341, a first sensor film 342, a second optical film 343, a second sensor film 344, and a third optical film 345 which are stacked sequentially. The touch element 340 can be adhered to a bottom surface of the cover 320 by applying a mature glass-film-film adhesion technique.

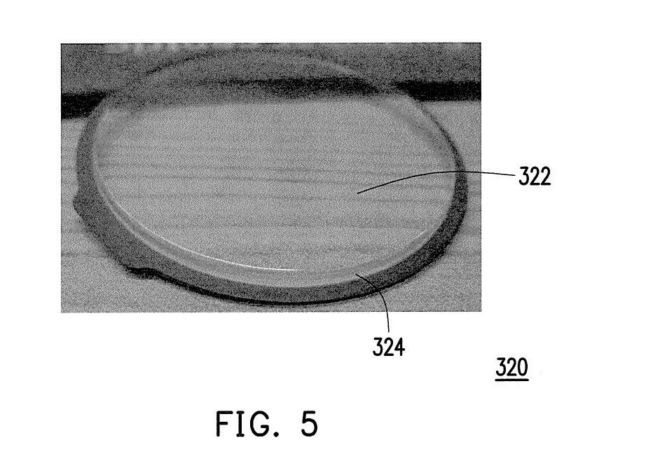

FIG. 5 is a photograph of a cover according to an embodiment of the disclosure. With reference to FIG. 5, the main body portion 322 and the step portion 324 of the cover 320 are integrally formed. The main body portion 322 can be circular, the step portion 324 is located at a periphery of the main body portion 322, and a thickness of the step portion 324 is less than a thickness of the main body portion 322. However, the cover 320 is not limited to be of the circular shape; based on actual demands for the exterior design of electronic products, the cover 320 can have a square shape, a rectangular shape, or any other appropriate shape. The manufacturing yield of the cover 320 can reach at least 97%, and thus the cover 320 is characterized by mass productivity.

As shown in FIG. 4, the touch module 300 may further include a shielding layer 350 arranged on the bottom surface of the cover 320. The shielding layer 350 may be printed on the bottom surface of the cover 320, so as to prevent the users from observing the internal electrical circuits through gaps 360. It should be mentioned that the shielding layer 350 is printed on the bottom surface of the cover 320 and is thus dissimilar to the conventional decorative sheet 240 that is stacked and adhered onto other films, and thus the resultant cover 320 can have the small thickness. Besides, the shielding layer 350 can be formed on parts (not shown) of the bottom surface of the cover 320 corresponding to the gaps 360, and thereby the amount of the material used for performing the printing process can be reduced.

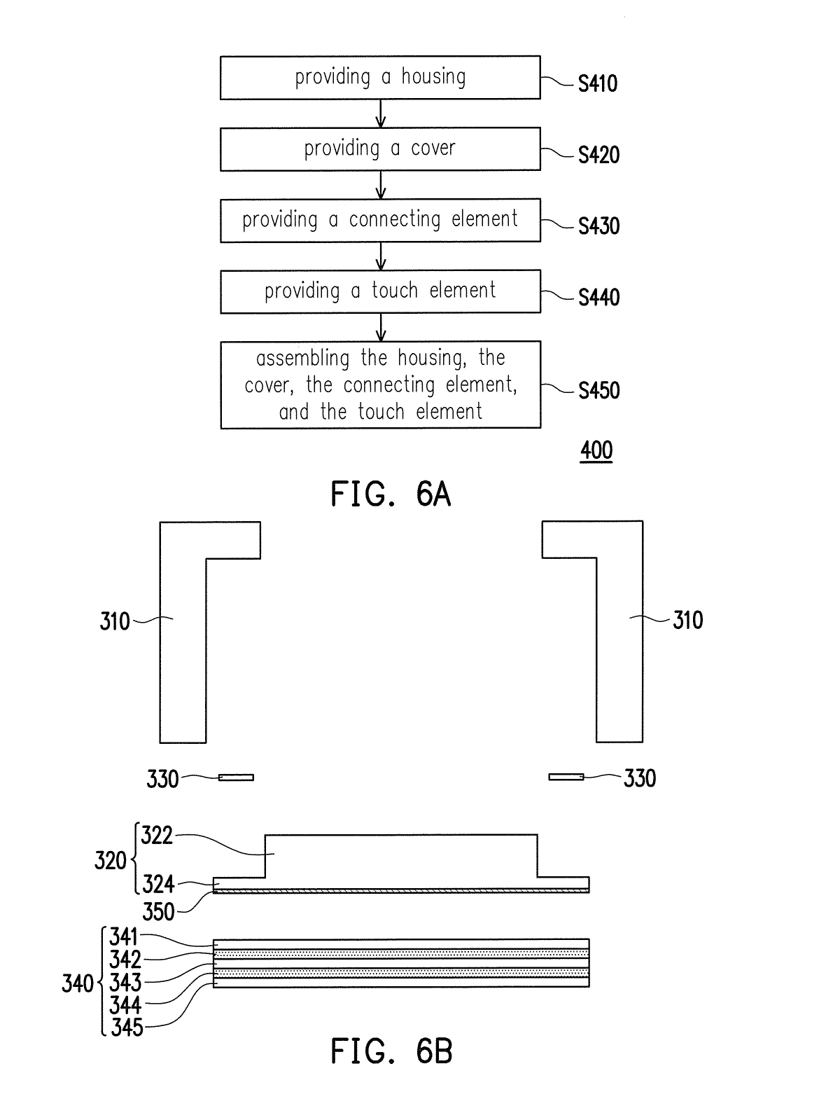

FIG. 6A is a flowchart illustrating a fabricating method of a touch module according to an embodiment of the disclosure. FIG. 6B is a schematic diagram illustrating a process of assembling a touch module according to an embodiment of the disclosure. With reference to FIG. 6A and FIG. 6B, the fabricating method 400 of the touch module may include following steps. In step S410, the housing 310 is provided. In step S420, the cover 320 is provided. In step S430, the connecting element 330 is provided. In step S440, the touch element 340 is provided. In step S450, the housing 310, the cover 320, the connecting element 330, and the touch element 340 are assembled. Structures of the housing 310, the cover 320, the connecting element 330, and the touch element 340 and the applicable embodiments are described above and thus will not be further explained hereinafter.

Note that the order of assembling the housing 310, the cover 320, the connecting element 330, and the touch element 340 can be properly determined; for instance, in an embodiment of the disclosure, the cover 320 and the touch element 340 can be assembled first and are then assembled to the housing 310 via the connecting element 330. Alternatively, the housing 310 and the cover 320 can be firstly assembled via the connecting element 330, and the touch element 340 is then assembled to the bottom surface of the cover 320. Here, the assembling order of the components of the touch module 300 is not limited.

FIG. 7 is a schematic cross-sectional diagram illustrating a smart watch having the touch module depicted in FIG. 4. With reference to FIG. 7, the smart watch 500 includes said touch module 300 and a display element 510. Applicable embodiments of the touch module 300 are described above and thus will not be further explained hereinafter. The display element 510 may be a liquid crystal display panel, an organic light-emitting display panel, and so on. The smart watch 500 having said touch module 300 can have the border-free design, the first pass yield of assembling the smart watch 500 can be satisfactory, and the manufacturing costs can be lowered down.

To sum up, the touch module, the fabricating method thereof, and the smart watch having the touch panel can at least accomplish effects described below. The touch module can be characterized by the border-free design, the manufacturing costs of the touch module can be significantly reduced, the manufacturing yield of the touch module can be improved, the manufacturing steps of the touch module can be simplified, the manufacturing tolerance accumulated during the assembling process can be reduced, and the manufacturing reliability can be enhanced because the adhesion process is performed on the step portion of the cover.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. A touch module, comprising:
a housing;
a cover, comprising a main body portion and a step portion located at a periphery of the main body portion, a thickness of the main body portion being greater than a thickness of the step portion;
a connecting element, located between the step portion and the housing; and
a touch element, located at a side of the cover and at an inside of the housing.

2. A touch module of claim 1, wherein
the touch element comprises:
a first optical film, a first sensor film, a second optical film, a second sensor film, and a third optical film stacked sequentially.

3. The touch module of claim 1, wherein
the housing comprises an opening, and
the main body portion is lodged in the opening in an inside-out manner from the inside of the housing.

4. The touch module of claim 1, wherein
the housing has a horizontal extension portion and a vertical extension portion, and
the connecting element is located between the step portion and the horizontal extension portion.

5. The touch module of claim 1, further comprising:
a shielding layer, arranged on a bottom surface of the cover.

6. A fabricating method of a touch module, comprising:
providing a housing;
providing a cover, the cover comprising a main body portion and a step portion located at a periphery of the main body portion, a thickness of the main body portion being greater than a thickness of the step portion;
providing a connecting element, the connecting element being located between the step portion and the housing;
providing a touch element, the touch element being located at a side of the cover and at an inside of the housing; and
assembling the housing, the cover, the connecting element, and the touch element.

7. The fabricating method of claim 6, wherein
the touch element comprises:
a first optical film, a first sensor film, a second optical film, a second sensor film, and a third optical film stacked sequentially.

8. The fabricating method of claim 6, wherein
the housing comprises an opening, and
the main body portion is lodged in the opening in an inside-out manner from the inside of the housing.

9. The fabricating method of claim 6, wherein
the housing has a horizontal extension portion and a vertical extension portion, and
the connecting element is located between the step portion and the horizontal extension portion.

10. The fabricating method of claim 6, further comprising:
forming a shielding layer on a bottom surface of the cover.

11. A smart watch, comprising:
a touch module, comprising:
a housing;
a cover, comprising a main body portion and a step portion located at a periphery of the main body portion, a thickness of the main body portion being greater than a thickness of the step portion;
a connecting element, located between the step portion and the housing;
a touch element, located at a side of the cover and at an inside of the housing; and
a display element, located at a side of the touch element.
